(19) United States
(12) Patent Application Publication
(10) Pub. No.: US 2024/0410331 A1
(43) Pub. Date: Dec. 12, 2024

(54) Wind Energy Turbine Blade Second Element Negative Pitch Angles

(71) Applicant: Anthony Vincent Chessick, Tehachapi, CA (US)

(72) Inventor: Anthony Vincent Chessick, Tehachapi, CA (US)

(21) Appl. No.: 18/445,239

(22) Filed: Jun. 12, 2023

(51) Int. Cl. F03D 1/06

(52) U.S. Cl. CPC F03D 1/06495

(57) ABSTRACT

Wind energy has considered blade designs, involving negative blade pitch angle DEFLECTION of the wind, to have no acceptance in the belief that such negative pitch angle DEFLECTION causes energy loss and not energy gain. However, better, more thorough study of the Laws of Motion is finding that these beliefs need correction.

Negative blade pitch angles can, in fact, under Theory, have quite significant blade power production capabilities on per unit of blade length bases. DEFLECTION Theory counts only the blade pitch angle for the blade driving force and power production and blades pitched negative can add significantly to the ordinary wind flow DEFLECTION of the blade.

Perhaps the best blade design for creating negative pitch angles involves the use of gapped blade second elements, themselves pitched negative.

The PTO lists five Statutory Classes that patents are allowed to be filed under. One is the “New Use of Conventional Machines” under which new, innovative uses are prescribed for machines in the public domain.

Here, therefore, the Conventional Machines are the ordinary single element blades available for such a New Use under this Patent Submittal.

The power added can be quite useful even on large multi-MW turbines where blade lengths are becoming at a premium.

### BACKGROUND OF THE INVENTION

The Invention relates to the generation of power, normally electrical power, by means of creating such power from the conversion of the kinetic energy available from wind in the atmosphere by means of the rotating blades of wind turbines.

Wind turbines have long made use of special profile blades not far dissimilar in profile, though narrower, to airplane wings to gather the energy from the wind. As the wind turbines have grown in energy rating and blade length of the three blades of typical construction, a need is surfacing to increase the efficiencies of the blades beyond the best blade profile designs so far available.

Airplane wings, however, do not have the same needs that wind turbine blades have and so differences exist that are found to be necessary for wind blades. For example, unlike airplane wings, wind turbine blades best need to increase the wind flow DEFLECTION of the incident airflow on a per-unit of blade length basis to be the most airflow DEFLECTION physically possible. Airplane wings have requirements to limit such airspeed flow DEFLECTIONS per unit wing span. The future of wind energy depends on the ability of wind blades to make use of whatever additional possible blade profile technology that is available in order to so maximize the wind flow DEFLECTION.

Integrity Energies—Wind Company, of which the inventor is owner, holds, as quite basic to aerodynamic theories, a variation of Newton's Law applicable to fluid flow, for the design of wind turbine blades. In a Newton's Law-based vector force formula, derived with high academic level math and physics, it is held that the blade driving forces are dependent on the DEFLECTION of the apparent wind flow impacting the blades. Thus, improvements to the wind flow DEFLECTIONS increase the efficiencies of the blades.

### SUMMARY OF THE INVENTION

At this point the basic Science must be made clear. Wind is heavy, two pounds per cubic yard, heavier than wind is often given credit for. All current wind turbine theories do not stress the single, main source of blade energy capture, that is, wind flow DEFLECTION of the heavy wind to create a force. “The greater the DEFLECTION”, to a certain extent, equals “the greater the force”.

Wind energy has long held the belief, being hereby challenged herein, that pitching blades negative and adding second elements with a gap to blades have entirely no use and limit performance. This is seen every day with the blades on all wind turbines, universally single element and pitched to zero degrees.

The understanding in wind energy is that pitching of the blades negative, that is, DEFLECTING the wind back upwind, is a loss of power instead of a gain in power and is to be entirely avoided. But as long as the wind being so DEFLECTED back upwind is at a velocity that is less than or, at most, equal to the full ambient wind velocity approaching the blade, the wind so DEFLECTED upwind is reversed and nullified by the ambient wind velocity approaching the blade and does not continue upwind. Slowing the ambient wind, a side effect of such upwind velocity from negative blade pitching, is a means, in fact, of adding energy to the blade since this is a removal of wind kinetic energy.

Pitching the blades negative, to a certain extent, does not reduce power per se but, on the other hand, adds to the blade pitching angle beyond zero degrees pitching of the blade and thereby adds to the total DEFLECTION obtained by the blade. The DEFLECTION Theory requirement is that the DEFLECTION added thereby increases the power.

However, an aerodynamic restriction is the fact that single element blades, which are the standard blade design, have an inherent inadequacy that prevents wind flow DEFLECTION past only about 10 to 15 degrees, a fact which has been studied thoroughly in aviation wings. But a solution is available.

Similar facts surround the use of negative pitched second elements with gaps added to blades, considered to have no value within wind energy practice. But such added second elements themselves can have a fully useful negative pitch angle that also solves the problem of overcoming the inadequacy of limited single element blade pitch DEFLECTION as mentioned above. The second elements eliminate flow separation on the upper surface of the main blade, extending greatly the range of angular degrees of wind flow DEFLECTION possible, quite an important benefit.

So, it can be said that what is considered to be of little use and even to be considered detriments to blades in current wind technology is in need of being given a correct understanding in order to be accepted in making New Use of blade profile pitching by means of the use of negative pitch angles.

The Statutory Class of the Invention is heretofore selected to be “5—New Use of Conventional Machines” entitled a “Negative Pitched Double Element” design feature added to the blade. A Blade Second Element added to wind turbine blades is one component of the Conventional Machine and a Negative Pitched Adjustment to the Wind Turbine Blade is the second component of the two components Conventional Machine.

The two-component Conventional Machine added to the blade operates under the New Use thereby to cause a greater wind flow DEFLECTION per unit blade length and thus adds power to the blade.

Experiments and testing of modified blades introducing the design in an introductory manner of the New Use of negative pitched second elements have verified that the unexpected added energy has been seen as expressed quite strictly in Theory.

### DESCRIPTION OF THE DRAWINGS

FIG. 1 is a general representation of a standard horizontal axis wind turbine with different parts numbered and identified.

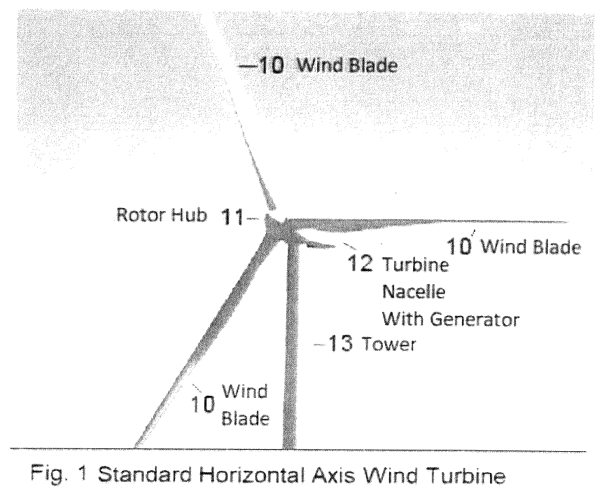

FIG. 2 are two blade profile drawings showing how a blade pitched negative can, with the availability of wind, produce a driving force and thus wind turbine power. In the below image with the availability of wind, negative blade pitching lengthens the “F” Force Vector due to the substantial 30°+15°=45° DEFLECTION of the heavy apparent wind mass. This added DEFLECTION, with its force, is imposed on the blade at blade surfaces. Farther away from the blade surfaces, the DEFLECTIONS with associated forces taper off but are available to add additional flow DEFLECTIONS with forces to the blade.

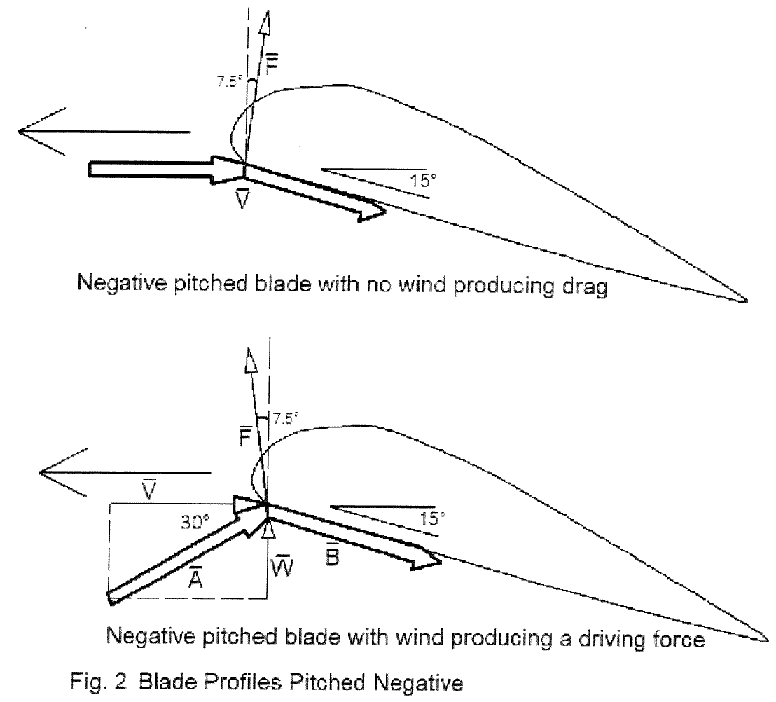

FIG. 3 shows an example of the first component of the herewith proposed New Use of a Conventional Machine, a strong, thin, narrow length of substance such as metal plate with an airfoil profile, called a “second element”. The second element is attached to the wind turbine blade with bolts or other means including bracing to complete the structural design.

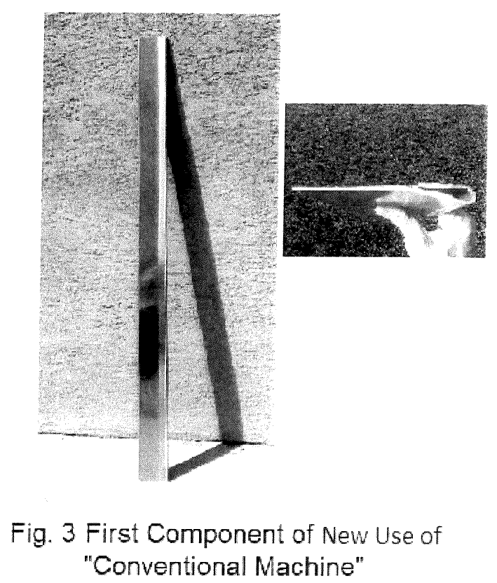

FIG. 4 shows an example of the second component of the herewith proposed New Use of a Conventional Machine, showing a cross section view of a blade segment being pitched to a negative pitch angle.

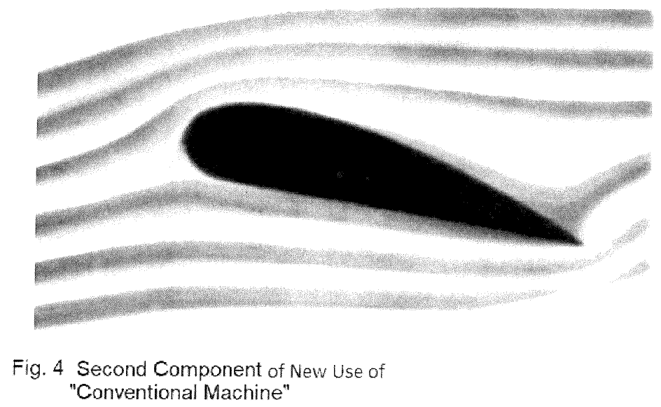

FIG. 5 shows three example cross sections of how generally the second element is attached to the blade using bolts, with three different second element negative pitch angles.

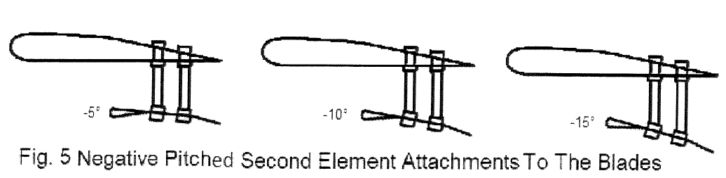

FIG. 6 shows a Wind Tunnel streamline view of a blade segment pitched to zero degrees with a sketched in New Use of a Second Element Component as a Conventional Machine. The Second Element Component is pitched to minus 15 degrees showing how the assumed changes to the streamlines resulting add to the streamline DEFLECTIONS and how such changes would result in creating additional driving forces.

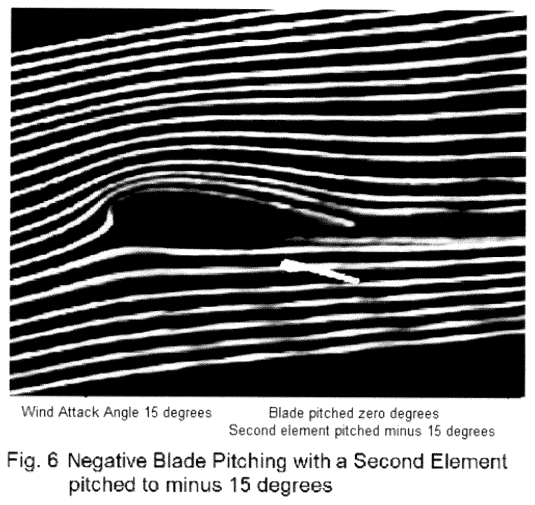

FIG. 7 shows a Wind Tunnel streamline view of a blade pitched to minus 10 degrees as a New Use of a Pitched Blade Component as a Conventional Machine but with a negative pitch angle. Also added is a sketched in New Use of a Second Element Component as a Conventional Machine. The Second Element Component is pitched to minus 25 degrees showing how the assumed changes to the streamlines resulting add to the DEFLECTIONS, and thereby to the driving forces. An additional feature is that the turbulence caused by flow separation above the blade is well eliminated, an aerodynamic feature of the added Second Element, allowing the streamlines to retain the laminar flow characteristic, preventing the negative pitched blade DEFLECTION from being lost.

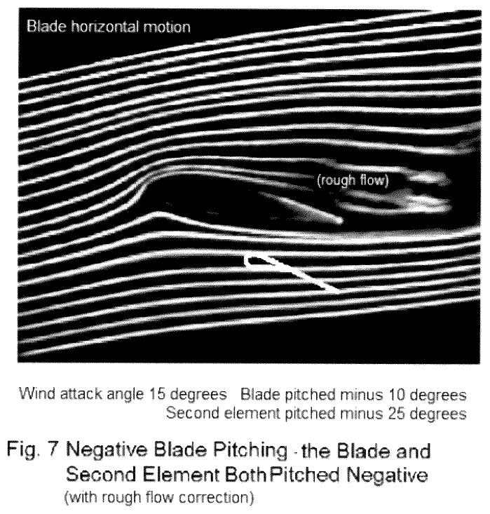

I claim:

1. A thin material of a prescribed strength, width, length, and thickness profile of aerodynamic shape that is fastened with suitable length bolts adjacent, but not in contact, that is, leaving a non-parallel gap, with one side of the said thin material length, to each wind turbine blade, the said non-parallel gap designed to change the direction of the wind entering the gap to be outwards away from the blade as a pitch angled DEFLECTION.

2. The said thin material of claim 1 is named a blade second element, being generally flat but with a rounded, folded back leading edge on one side, designed to prevent flow separation during the flow DEFLECTION at the leading edge.

3. A wind turbine blade comprising the blade and an attached second element of claim 1 or other means for limited additional DEFLECTION of the incident wind by the blade in the negative direction, that is, in the direction back upwind, the said additional DEFLECTION being a method of increasing power.
